(19) United States
(12) Patent Application Publication
(10) Pub. No.: US 2006/0253313 A1
(43) Pub. Date: Nov. 9, 2006

(54) Process for developing business proposals

(76) Inventors: Jay D. Divine, St. Louis, MO (US); Wilson D. Yates III, Lake St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/121,771

(22) Filed: May 4, 2005

(51) Int. Cl. G06F 9/46

(52) U.S. Cl. 705/9

(57) ABSTRACT

A method for formulating a business proposal in response to a customer solicitation includes (1) developing a proposal launch package in which is set forth the information needed for the proposal and a framework for obtaining the information; (2) conducting an interactive storyboard review workshop; (3) conducting an interactive offer development workshop and initiating development of an integrated master plan and schedule for the project; (4) conducting interviews with subject matter experts; and (5) drafting proposal content for them to review. Information is collected in accordance with tasks outlined in the framework and this information is used to produce an initial draft of the proposal. This draft is reviewed and revised in response to critiques of the draft; subsequent drafts include additional information identified as being needed in a completed proposal. This approach enables the proposal team to reach a consensus, early in the proposal process, on a detailed response to the solicitation and significantly reduces the time and cost burdens involved in preparing the proposal.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to business processes; and particularly, to a process for producing proposals for submission to the government or other businesses. The process is particularly beneficial for streamlining the preparation of complex technical proposals submitted to governmental agencies and business clients; these proposals ranging in size from fifty or so pages to hundreds, or thousands of pages, and often including highly technical and complex content. The process of the present invention allows a proposal group to develop and produce a proposal faster and more cost effectively than is now possible using conventional approaches.

In order to obtain significant new business, many companies have to prepare and submit a proposal to a government agency (federal, state, or local) or to a company awarding the business. The proposal is then compared with competing proposals submitted by others. Most often, there is a predetermined set of criteria against which the proposals are judged and upon which the winning proposal is selected. Failure to win a proposal often represents a major setback to a company, and sometimes can sound a death knell for the company. Major new business proposals to the government, especially those required of aerospace and defense contractors, are recognized as creating a chronic challenge to a company, and one that stubbornly resists being resolved by management.

It is now well recognized within management that these types of proposals are labor intensive, usually run well behind schedule, and usually run well over budget. Studies show there are many reasons for this. First, the proposals entail a highly complex and extended communications exercise, and few team members have the type of communications skill required for such an exercise. Second, rewards and incentives associated with working on a proposal are intangible at best, while the penalties and disincentives (overtime and weekend work, neglected work on other projects) are clear and present.

Next, an organization's best technical people are usually those selected to work on critical proposals. But, they are also usually the ones who typically have the heaviest work loads. It will further be appreciated that most complex proposals include a significant number of critical tasks that must be completed in accordance with a fairly rigorous schedule, and involve frequent, extensive management reviews. And all this work must be done in accordance with a short (one or two months), inflexible deadline. Because no one relishes added work, most proposal teams start late, and work in a reactive, “fire-fighting” mode that makes it difficult to manage proposal preparation and allocate resources effectively.

Because of the constant pressures, proposal teams almost always fail to take the time to stop and focus on a critical “up-front” activity; namely, establishing a detailed definition of the offer they want to present in the proposal. Rather, the emphasis is on “getting going”, with the assumption that the offer will be defined as the proposal takes shape. However, the failure to define the offer, up front, is often fatal and undermines many proposal efforts. Because the proposal time line leaves so little time to organize and manage, and because the offer, in effect, becomes a moving target, much of the proposal team's activity winds up being “reinventing the wheel”. Further, a lot of proposal content is laboriously developed, and then thrown away as directions change and the context of the proposal becomes clearer. It will be appreciated that generating proposal content for complex processes and/or advanced technologies is arduous to begin with. Unless the technical people on the proposal team are trained or experienced communicators, facing a blank sheet of paper, or a blank computer screen, becomes a daunting and time-consuming task.

Finally, the cost of preparing a proposal, especially a complex one, is significant. It has been found that proposal teams are very weak when it comes to estimating proposal costs in advance, and costs often climb rapidly unless the team is carefully organized. Exacerbating the problem is the desperation that arises as the deadline for submitting the proposal nears. Often, the only solution seems to be to throw extra people, with their attendant cost, into proposal preparation as time runs out. When this happens, the quality of the final submittal is seldom what it should be. The overall result is that i) winning the proposal competition is put at significant risk, and ii) proposal costs are substantially over budget.

### BRIEF SUMMARY OF THE INVENTION

The proposal process of the present invention is directed to providing tools and activities which facilitate accomplishing the most burdensome and time consuming tasks associated with preparing a proposal, particularly proposals involving complex programs and technologies. In accordance with the process, streamlined approaches, tools, and templates are provided by which a relatively small, cross-disciplinary team of proposal process experts (usually four to six people) relieves a main proposal team (often 20 to 30 people) of the most difficult and most time-consuming tasks involved in developing a proposal. The process has been developed and tested by a group of professionals who understand both government-sector and commercial-sector program management and business development environments. The experience base of the group includes developing and implementing business acquisition processes for leaders in a number of industries, and developing and delivering hundreds of winning proposals. The small, hand-picked lean team (LPT) referenced above works under the direction of a main-team campaign leader, a program manager, and a proposal manager.

The process first involves supporting the development of an offer. Next, it involves analyzing the solicitation and mapping the requirements for the proposal. Once these steps are complete, an integrated master schedule (IMS) is developed, as is a proposal launch package. Available data is now collected from team leaders and technology experts. This will usually require conducting structured interviews with these individuals. Next, proposal text and graphics are developed. Management and technical reviews are then held and revisions are made to the proposal based upon these reviews. Once the reviews and revisions are complete, the final proposal is produced and submitted to the requestor.

Other objects and features will in part be apparent and in part be pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a block diagram representation showing an overview of the proposal process of the present invention;

FIGS. 2A and 2B illustrate the steps involved during a first phase of the proposal process;

FIGS. 3A and 3B illustrate the steps involved during a second phase of the process; and,

FIGS. 4A and 4B illustrate the steps involved during a third phase of the process.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

In accordance with the method of the present invention, the proposal process is based upon use of a relatively small, “hand-picked” lean proposal team (LPT) working under the direction of one or more campaign team leaders (i.e., those in charge of the solicitation response), and a program manager and/or proposal manager (PM). The proposal team performs the following functions:
a) it supports the development of an offer;
b) it analyzes solicitation and mapping requirements;
c) it initiates development of the integrated master schedule (IMS);
d) it develops a proposal “launch” package, including a proposal outline, a compliance matrix, storyboard templates, preliminary interview questionnaires, and a proposal schedule.
e) it collects available data from various team leaders and subject matter or technology experts SMEs;
f) it conducts structured interviews with these team leaders and SMEs;
g) it develops the proposal content, including both the textual and graphic elements of the proposal;
h) it incorporates various revisions to the proposal resulting from reviews by management personnel and technical reviewers; and,
i) it supports the production of the final proposal and its submittal.

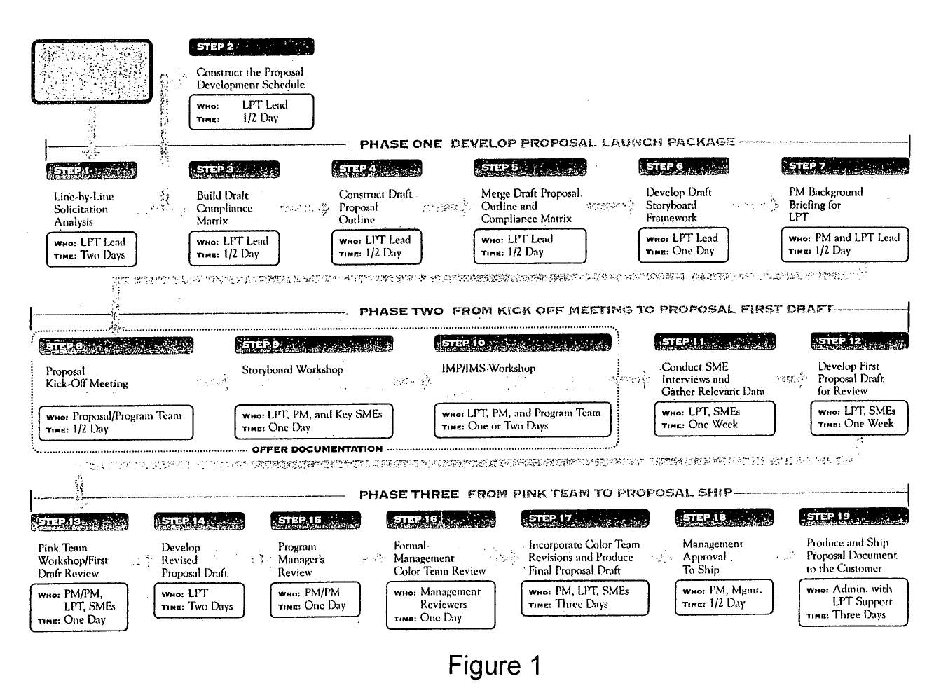

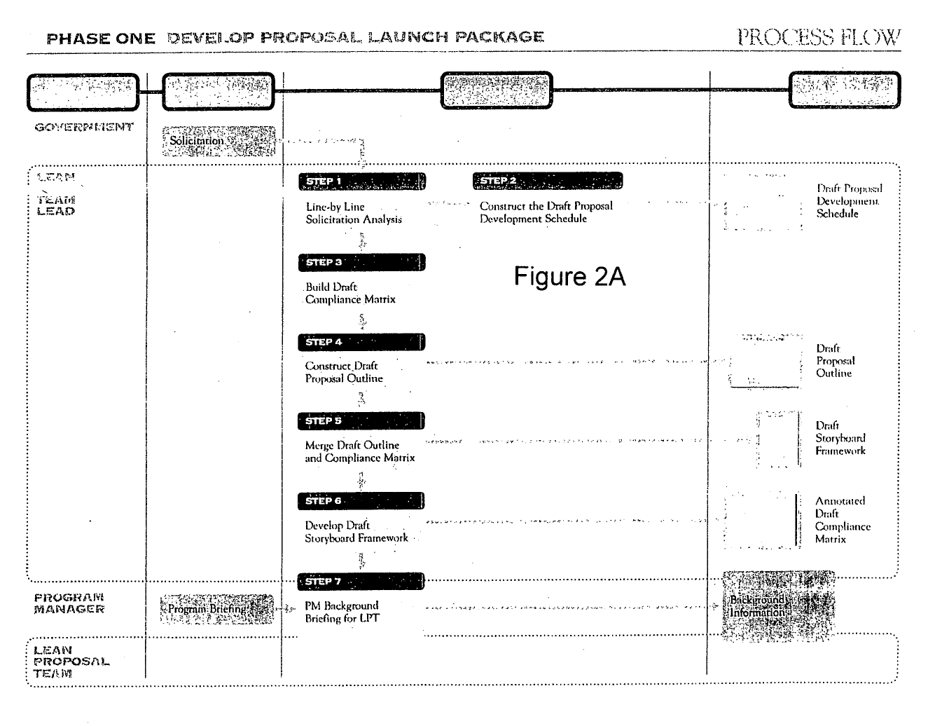

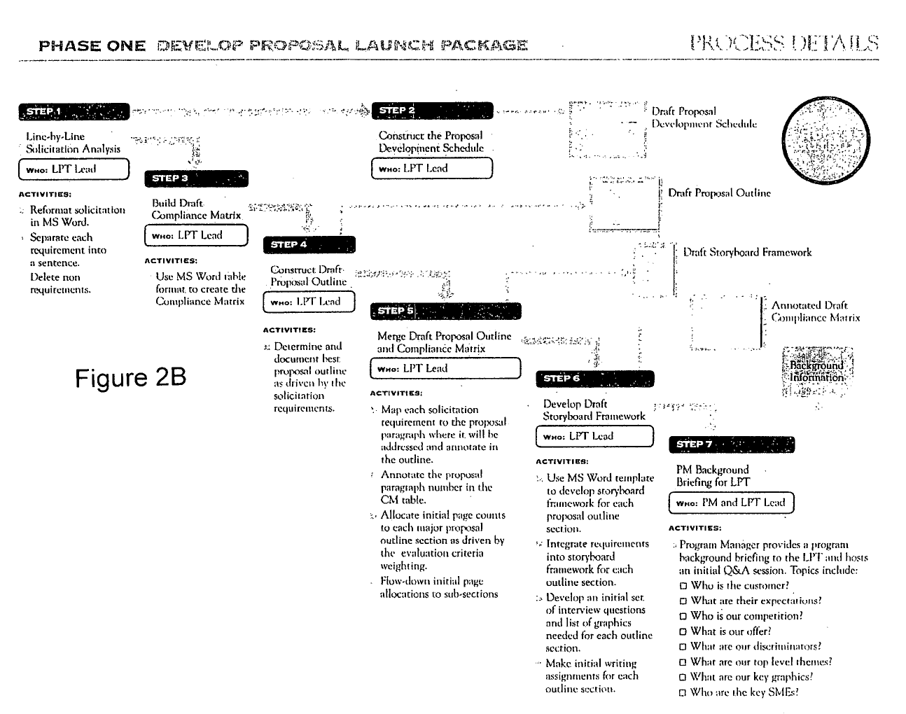

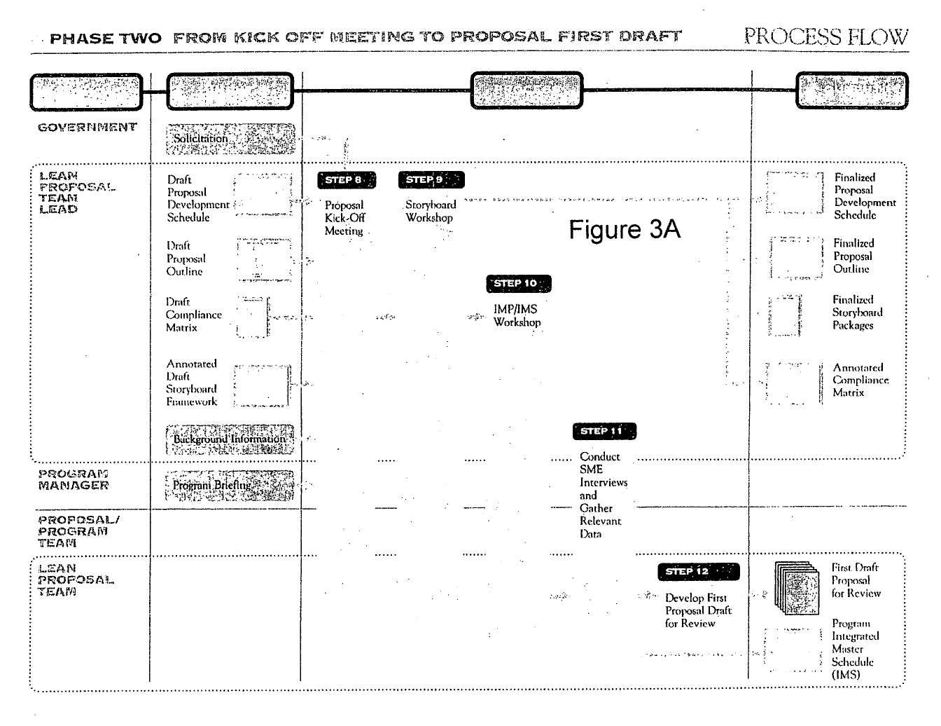

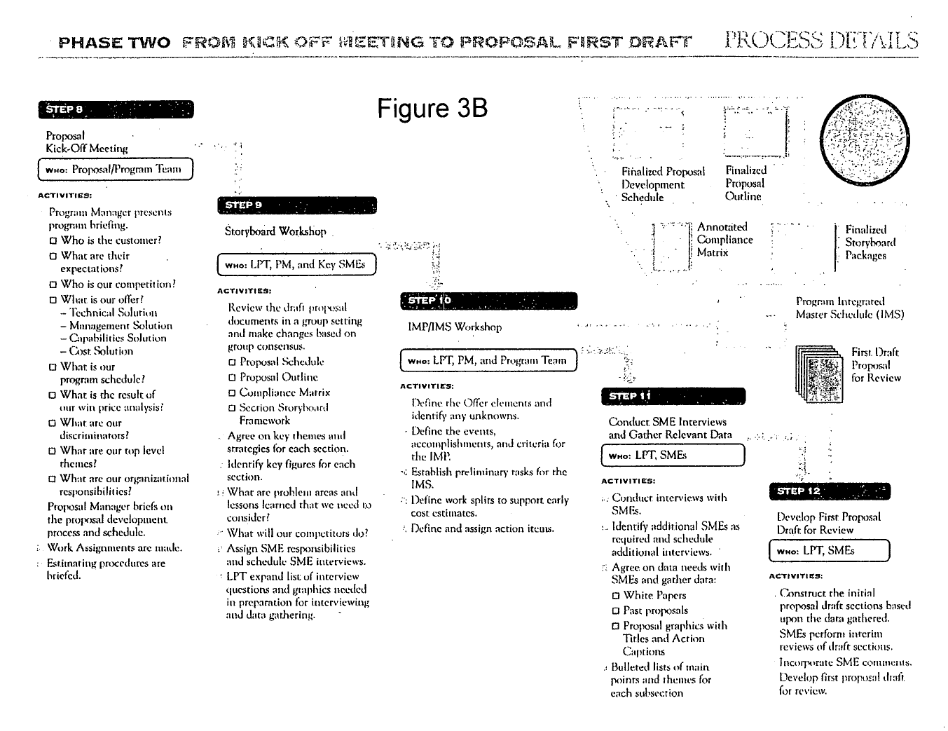

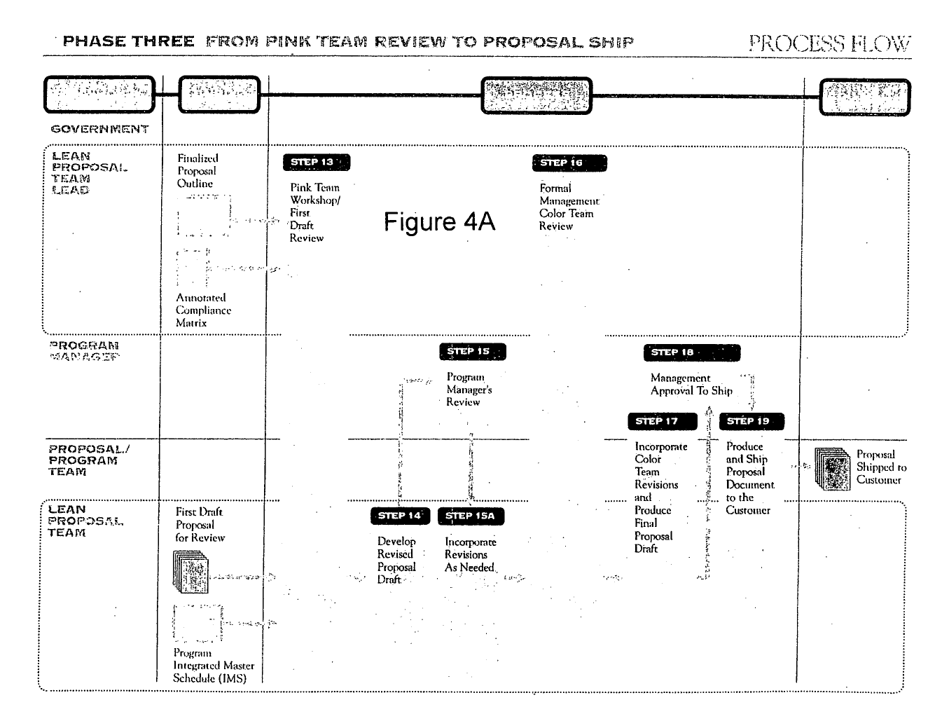

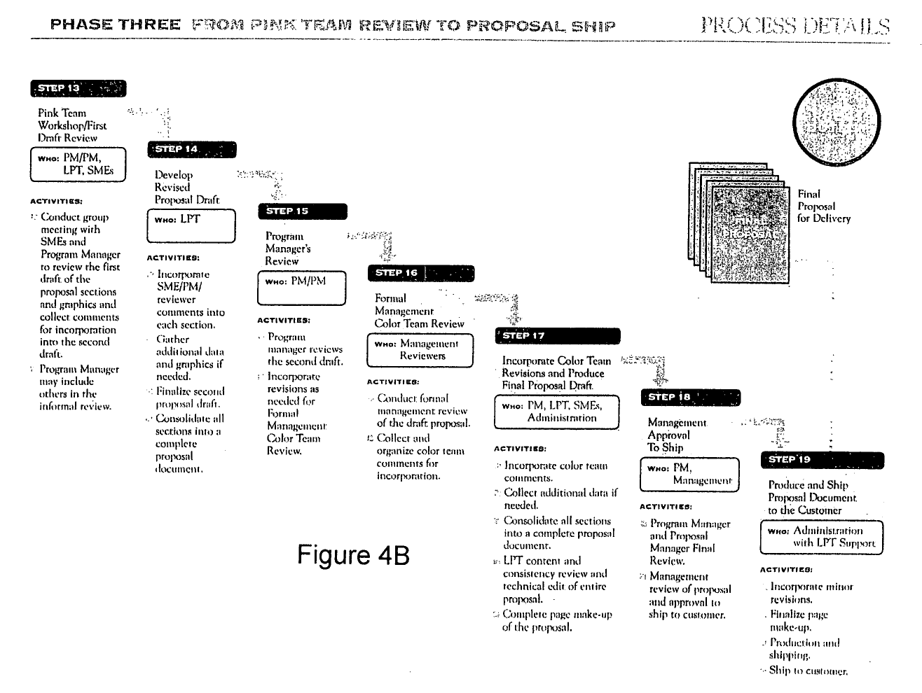

Referring to FIG. 1, in accordance with the steps set forth in the overview of the process, the process can be broken down into three separate phases commencing with the release of a solicitation for a proposal to the LPT. Phase one involves development of a proposal launch package and is described in more detail with respect to FIGS. 2A and 2B. Phase two involves work on the proposal from an initial “kick-off” meeting to the completion of a first draft of the proposal and is described in more detail with respect to FIGS. 3A and 3B. Phase three involves development of the proposal from completion of the first draft to completion and shipment of the proposal to a customer and is described in more detail with respect to FIGS. 4A and 4B. As shown in FIG. 1, phase one comprises seven steps which are expected to be accomplished within approximately 5 working days. Phase two comprises five steps which are expected to be completed within approximately 16½-17½ working days. Phase three comprises seven steps which are expected to be completed in approximately 11½ working days. In other words, from start-to-finish, i.e., from release of a solicitation to delivery of a completed proposal to a customer, the proposal process can often be less than 30 working days, depending on the required length of the proposal.

As a practical matter, before a solicitation is released, the LPT works with a management group for the proposal or business sector to develop proposal strategies, support critical areas of offer development including workshops on the subject, develop accurate forecasts of resources which will be required to complete the proposal, and develop a reliable cost estimate for the proposal process.

Referring to FIGS. 1, 2A, and 2B, once a solicitation is released, it is carefully reviewed and the LPT completes a preliminary analysis of requirements for the proposal and creates a proposal launch package (Step 1). This involves a line-by-line analysis of the solicitation, identifying each and every requirement and expressing it in a separate, discrete sentence; while, at the same time, deleting non-essential elements. As part of Step 1, the LPT gathers existing data on relevant technical and management solutions (including government and contractor briefings), white papers, company reports, and past proposals on similar projects.

At the same time Step 1 is performed, a proposal development schedule is also being produced (Step 2).

Next, the LPT drafts (Step 3) a requirements compliance matrix (CM) that includes a table (not shown) by which the completion of identified tasks is tracked. The LPT further drafts an initial proposal outline (Step 4) representing the best outline possible based upon the requirements of the solicitation and the current level of information about the proposal. These are then merged together at Step 5. Step 5 includes mapping each solicitation requirement to the paragraph in the proposal where it will be addressed, and annotating the initial outline of the proposal accordingly. It also includes annotating the proposal paragraph number in the CM table, and establishing initial page counts for each major proposal outline section. This is based upon an evaluation weighting criteria as to how much information needs to be presented to address each issue within the proposal and includes a flow-down from an initial page allocation into allocations for each sub-section within the section.

With the merged proposal outline and compliance matrix in place, a storyboard framework for each outline section is created (Step 6). The storyboard delineates the type of information necessary to complete the particular section of the proposal. LPT members use the storyboard to develop an initial set of detailed interview questionnaires, and a list of graphics (flowcharts, technical illustrations, etc.) needed for each section. These are prepared so they can be “mapped” directly to the identified requirements. Initial writing assignments for each outline section are made at this time.

Once the proposal launch package has been completed, the program or proposal manager briefs LPT leaders on the proposal and what is required to formulate it (Step 7). As part of the briefing, the following topics are addressed:
a) who is the customer?
b) what are the customer's expectations?
c) who is the competition?
d) what will the company's offer be in the way of i) a technical solution,
   ii) a management solution, iii) a capabilities solution, and iv) a cost solution?
e) what factors (discriminators) will the company use in preparing its proposal?
f) what will the company's “top level” theme(s) be?
g) what are the company's key graphics?
h) who are the key technical or subject matter experts (SMEs) whose input will be needed to prepare the proposal.

Completion of this meeting completes the first phase of the proposal process.

Referring to FIGS. 1, 3A, and 3B, phase two of the proposal process begins with a kick-off meeting (Step 8) with members of the proposal/program team. At this meeting, the program manager gives a briefing reviewing the items discussed with the leadership in Step 7. In addition, the proposal manager presents a briefing on the proposal development process and work schedule, and a briefing on time and cost estimations.

The “kick-off” meeting is followed by a storyboard workshop (Step 9) which includes the LPT, program and proposal managers, and key SMEs. During this workshop, draft proposal documents are reviewed and modified depending upon the consensus of the group. These include those relating to the proposal timing schedule and outline, the compliance matrix, and section framework. The group further discusses and decides key themes and strategies to be developed for each section, key people involved with each section, problem areas which may arise, and possible actions or strategies which may be implemented by the company's competitors. SME responsibilities are assigned and interviews scheduled. If appropriate, the LPT expands the list of interview questions, and adds any other graphics needed for interviews and other data gathering. When the workshop is completed, the proposal development schedule, proposal outline, compliance matrix, and storyboard packages have either now been completed or are being placed in their final form for putting the proposal together.

Following the storyboard workshop is an offer development workshop which is also referred to as integrated master plan/integrated master schedule or IMP/IMS workshop (Step 10). This workshop involves the LPT, PM, and program team. The workshop addresses issues such as which offer elements are currently known and which are not. It further defines those events, accomplishments, and criteria for the IMP, and establishes preliminary tasks for the IMS. At the workshop, the work necessary to support preliminary cost estimates is divided up among team members, and other action items are defined and assigned to appropriate personnel.

Once all the workshops are finished, the next step (Step 11) begins; it includes conducting interviews with SMEs and gathering other relevant data needed to develop proposal content. Sometimes, as a result of an interview, it is determined that other people also need to be interviewed and, as they are identified, interviews with them are scheduled. As part of the interview process with the SMEs, information required for preparing the proposal (and sources of that information) is identified, and collected. As interviews and information gathering proceeds, an initial draft of the proposal starts to take shape. Part of this process involves the preparation of preliminary graphics including titles and captions; and main points and themes to be emphasized for each portion (subsection) of the proposal are identified.

As Step 11 proceeds, Step 12 is begun. Here, a first draft of the proposal is prepared by the LPT. The contents of each section are based upon the data and information initially gathered from interviews and other sources. As the various sections are completed, they are reviewed by the relevant SMEs and the comments of the SMEs are incorporated into the section drafts. After these interim reviews are complete, the first full draft of the proposal is readied for an overall review.

Referring to FIGS. 1, 4A, and 4B, phase three of the proposal process begins with a review of the completed first draft of the proposal (Step 13) with members of the proposal/program team. The review is part of a first draft review workshop that includes the LPT, SMEs, PM, and others. The team critically reviews the first draft, section by section, and provides comments as to the completeness of the information contained in the draft, its accuracy, items which may still be open, and any “gaps” in the proposal which may now have come to light.

The next step (Step 14) is for the PM to take all of the criticisms and comments resulting from the first draft review workshop and incorporate them into the appropriate section (or sections) of the draft. In addition, the PM puts together a list of tasks or action items which the LPT now needs to address. This may result in the LPT having to engage in another round of interviews with SMEs and additional information gathering. The results of these further activities are now incorporated into a second draft of the proposal.

Upon completion of preparation of the second draft, the PM (Step 15) reviews the new draft and incorporates any new revisions that may be needed prior to a formal management team review (Step 16) of the proposal. The critiques made by the reviewers, and their comments, are now incorporated into the proposal to produce a final draft (Step 17). Besides the reviewers' comments, further pertinent information and additional data which has now been collected is incorporated into the proposal at this time. All of the sections, some of which may have been separately reviewed by selected team members, are combined with the rest of the draft to produce the completed proposal. A technical edit and consistency review is performed to ensure completeness of the information, its accuracy, the consistency of the material presented throughout the proposal, and above all to ensure that the proposal is written with “one voice” throughout.

Once the revised draft is completed, it is given a final review by the proposal manager and program manager (Step 18). Once they are satisfied, the proposal is submitted to company management for their review and approval. After receiving management approval, the proposal is presented to the requestor/solicitor. As part of the transmission process (Step 19), any minor revisions which need to be made are incorporated, and the format (page make-up, artwork, etc.) are set into their final form. Thereafter, the proposal is printed and shipped.

A significant element of the proposal process is the use of the LPT. Unlike prior proposal efforts which employ somewhat of a “scattergun” approach of throwing resources at a proposal some of which are helpful, but many of which actually detract from the effort, the LPT and the above described process in which the LPT is effectively employed reduces not only the time and cost to prepare a proposal, but also produces a better proposal than has otherwise been produced.

There are a number of reasons for this.

First, the LPT is a cross-disciplinary team which is relatively small; typically consisting of 4-6 members. The LPT is led and coordinated by a team leader who works closely with the PM, facilitates the offer development workshop (Step 10), and takes the lead in developing a proposal launch package. The team leader works at the deputy proposal manager level. Another team member is an IMP/IMS expert who helps run the offer development workshop and develops the master schedule. Other team members consist of senior level proposal process experts and analysts who combine technical backgrounds with high-level communications skills, including interviewing, data gathering and interpretation, customer analysis, technology story telling, and technical editing. In this regard, the team members know how to use highly structured interviewing techniques to effectively “pick the brains” of designated technical and subject matter experts (SMEs), and others, whose knowledge is crucial to putting together a winning proposal. Typically each LPT interview is conducted by a sub-team of two people, one with a strong technical background, the other with a strong technical communications background. This ensures a high degree of accuracy in capturing extremely complex subject matter.

The LPT members have established proficiency at gathering existing data on relevant technical and management solutions (including government and contractor briefings), white papers, company reports, and past proposals on similar projects. They are thus able to combine all of the acquired data, and interview results, to write, compose, and assemble the text and graphics required for the proposal.

The significance of this part of the Lean Proposal Process is that SMEs and proposal team managers, who heretofore have been the ones expected to draft the proposal, now become reviewers instead of authors. Now, rather than writing the drafts, they review and revise the draft materials developed by the LPT, which is a much more efficient use of their time.

After each review, it is the LPT members who incorporate revisions resulting from reviews and provide a revised and updated draft (with new information and data identified from the previous review) for the next review. The LPT members further support the final production and submittal of the completed proposal.

A key element of the process of the invention is the offer development workshop. Studies have shown that a major difficulty in the proposal process is a failure by a company to effectively define its offer early in the process. The offer development workshop overcomes this critical (but commonly overlooked problem) by addressing and resolving issues related to this aspect of the proposal up front when it will do the most good. The focus of the workshop is to structure and populate, in real time, a preliminary IMS for the work to be done in response to the solicitation requirements; and in doing so, to have the proposal team reach a consensus, early in the process, on a reasonably detailed response to the solicitation.

Another key element of the workshop is to ensure that the proposal team focuses on the total offer the company will present in its proposal. This means a focus not only on a technical solution, but the organization's management and other capabilities (engineering, manufacturing, etc.), and cost solutions as well. As previously noted, a chronic weakness of conventional proposal teams is the tendency to focus on the technical solution while ignoring these other critical areas.

The purpose of the workshop is to formulate the company's response to a solicitation, and design and implement a strategy for development of the proposal. Ideally, the workshop should precede release of a formal solicitation by the customer. The workshop is jointly facilitated by the LPT team leader working at the deputy proposal manager level, and an IMP/IMS expert. This latter person builds the IMS on-screen using a scheduling software application such as Microsoft Project® as the workshop progresses. Workshop participants include program and proposal managers, authors of record for major proposal sections, SMEs, key supplier representatives, contracts people, estimating professionals, and supplier management professionals, and the LPT proposal content developers.

Workshop activities take place in an interactive and collaborative environment, and they include the following:
a) review established strategy;
b) review the team's competitive assessment;
c) validate the proposal outline;
d) complete a work breakdown structure (WBS);
e) establish an appropriate organizational structure to match the WBS;
f) map suppliers and customers into the organization;
g) agree on program events;
h) identify the accomplishments associated with each event;
i) identify criteria/work packages for each section of the proposal and use this information to fill in positions on the IMS;
j) identify tasks to be done and the amount of time required to complete them;
k) monitor developing solutions against customer requirements;
l) allocate work loads among the team members;
m) establish responsibility for different work assignment;
n) draft preliminary Statements of Work (SOWs) for estimating the time and effort required to perform the various proposal tasks;
o) validate the resulting offer against the strategy initially developed;
p) identify past performance strengths; and,
q) identify any unknowns for post-workshop resolution.

The benefits obtained from an offer development workshop are immense. For example, the workshop requires a real-time, collaborative approach to integrating technical, management, capabilities, and cost solutions into an offer at the earliest possible time. Further, it requires full team member consensus on the “vision” behind an offer, and it establishes a solid structure upon which to build, validate, and document the team's solution to meeting a customer's needs. In addition, the workshop creates a productive environment for asking and answering critical questions, raising issues, and resolving problems associated with putting a proposal together. It effectively identifies the requisite expertise needed for, and allocates responsibility for, the development of individual sections of the proposal. It provides a reliable “outline” for describing the offer in a proposal format and begins filling in the outline with relevant information data. Finally, more than any other single factor in the process, the workshop sets the stage for accelerated completion of the proposal.

In summary, the proposal process of the present invention provides the following advantages over conventional approaches to proposal development.

First, it provides critical “hands-on” support where it is needed most by otherwise overburdened campaign and proposal teams.

Second, it effectively takes over the most time-consuming burdens of proposal planning, development, and production.

Third, it relieves the core proposal team of much of the busy work it previously had to do, and frees up program management, engineering, business, and technical resources to focus on leading the effort, and putting together a winning offer; while allowing these people to continue to focus on other critical projects.

Fourth, it accelerates the entire proposal process, enabling major proposals to be completed faster and more effectively.

Finally, It reduces costs by getting winning proposals completed on time using significantly smaller proposal teams.

In view of the above, it will be seen that the several objects and advantages of the present invention have been achieved and other advantageous results have been obtained.

Having thus described the invention, what is claimed and desired to be secured by Letters Patent is:

1. A method for formulating a business proposal in response to a customer solicitation comprising:
analyzing the proposal solicitation and mapping requirements for the proposal; collecting information for inclusion in the proposal;
preparing at least one draft of the proposal based upon the information collected, and reviewing the draft; and,
after the proposal is complete, submitting it to the customer, the method including use of a lean proposal team comprising relatively few persons, the lean proposal team carrying out the more time consuming and difficult tasks necessary to complete the proposal so to enable a proposal to be prepared and submitted quickly and relatively inexpensively.

2. The method of claim 1 in which analyzing the solicitation and mapping requirements for the proposal further includes developing a schedule for obtaining information relevant to the proposal and formulating and reviewing the proposal.

3. The method of claim 2 further including in which reviewing the proposal includes reviewing one or more drafts of the proposal.

4. The method of claim 1 in which analyzing the solicitation and mapping requirements for the proposal further includes preparing a proposal launch package for people involved in the proposal setting forth information required for completing the proposal.

5. The method of claim 1 in which collecting information for inclusion in the proposal includes:
identifying individuals within the organization having the information; and,
interviewing the identified individuals to obtain the information.

6. The method of claim 5 in which collecting information for inclusion in the proposal further includes preparing, in advance, structured interviews for each of the individuals.

7. The method of claim 6 in which each interview is conducted by two persons from the lean proposal team, one person with a technical background and one person with a communications background so to ensure a high degree of accuracy in capturing and communicating information obtained in the interview.

8. The method of claim 1 in which preparing at least one draft of the proposal includes preparing textual and graphic materials for inclusion in the draft.

9. The method of claim 1 in which the lean proposal team includes between 4-6 people.

10. The method of claim 9 in which the lean proposal team interfaces with management of the organization to develop a proposal strategy, identify and support critical areas of proposal development, and forecast resources and costs required to produce the proposal.

11. The method of claim 4 in which the lean proposal team performs an initial analysis of the proposal solicitation and creates the launch package identifying each and every requirement for the proposal.

12. The method of claim 5 in which the lean proposal team gathers information on technical and management solutions on previous proposals and similar projects which is relevant to preparing the proposal.

13. The method of claim 1 in which analyzing the solicitation and mapping requirements for the proposal further includes developing a compliance matrix of identified tasks related to preparing the proposal and tracks completion of the tasks on the matrix.

14. The method of claim 13 in which the lean proposal team creates a proposal outline setting forth the requirements of the solicitation and the information currently available about each requirement.

15. The method of claim 1 in which analyzing the solicitation and mapping requirements for the proposal further includes developing a storyboard framework based upon the compliance matrix and proposal outline, the storyboard delineating the information necessary to complete each section of the proposal.

16. The method of claim 1 in which analyzing the solicitation and mapping requirements for the proposal further includes developing detailed questionnaires for individuals within the organization having a requisite knowledge of information to be included in the proposal.

17. The method of claim 1 in which the lean proposal team conducts a critical review of a first draft of the proposal to determine the completeness and accuracy of information included in the proposal, the text and graphic content of the proposal, and any gaps in the proposal.

18. The method of claim 17 in which the lean proposal team, based upon the results of the critical review, creates a list of action items, including additional interviews, to address any shortcomings found in the first draft.

19. The method of claim 18 further including preparing a second draft of the proposal to include information now obtained to address those items included in list, the lean proposal team conducting a critical review of the second draft.

20. The method of claim 19 further including preparing and critically reviewing additional drafts, as necessary, until a satisfactory proposal is complete.

21. The method of claim 1 in which the lean proposal team is cross-disciplinary team.

22. The method of claim 21 in which the team members include one or more of the following skill sets: management processes; scheduling; technical background in a field relevant to the subject matter of the proposal, communications including interviewing, data gathering and interpretation; customer analysis; technology story telling; and technical editing.

23. The method of claim 21 in which the lean proposal team conducts an offer development workshop to define the scope and content of the organization's proposal, the workshop facilitating a real-time, collaborative approach to producing the proposal, and the workshop being conducted as early as practical in the proposal process.

24. The method of claim 23 in which the workshop addresses a total offer to be presented to the customer including a proposed technical solution, as well as the organization's management and other capabilities to affect the solution, and cost.

25. The method of claim 15 in which the lean proposal team conducts a storyboard workshop to capture proposal team consensus on themes, messages, and content points, and records these elements in the storyboard framework.
